(19) United States
(12) Patent Application Publication
(10) Pub. No.: US 2021/0363749 A1
(43) Pub. Date: Nov. 25, 2021

(54) DEPLOYABLE PERSONAL SAFETY SHIELD

(71) Applicant: Michael C. Jordan, Warwick (GB)

(72) Inventor: Michael C. Jordan, Warwick (GB)

(21) Appl. No.: 16/882,672

(22) Filed: May 25, 2020

(51) Int. Cl. E04B 2/74; E06B 9/24; E04B 2/78

(52) U.S. Cl. CPC E04B 2/7435; E04B 2002/7479; E04B 2/7845; E06B 9/24

(57) ABSTRACT

A deployable personal safety shield comprises a pair of longitudinally elongated members; a pair of bases for supporting the elongated members in an upstanding orientation; and a flexible member connectable the elongated members and extendable therebetween to provide an upstanding shield when the longitudinal members are spaced apart and supported by the bases.

### BACKGROUND AND FIELD OF THE INVENTION

This invention relates to the maintenance of personal hygiene and more specifically to the prevention of inadvertent, accidental, person-to-person transfer of bacteria, microbes, viruses and the like in a workplace resulting from normal respiration, person-to-person contact, and from persons speaking, sneezing and coughing in close proximity to co-workers. With the advent of the Covid-19 pandemic, the need for equipment facilitating such maintenance of social distancing, personal hygiene and prevention of person-to-person transfer of bacteria and viruses in schools, workplaces and other locales has become apparent. This invention addresses that need.

### STATEMENT REGARDING FEDERALLY-SPONSORED RESEARCH OR DEVELOPMENT

Not applicable—this invention was conceived and developed entirely using private source funding; this patent application is being filed and paid for entirely by private source funding.

### SUMMARY OF THE INVENTION

In one of its aspects, this invention provides a deployable personal safety shield, including a pair of longitudinally elongated members, a pair of bases for supporting the elongated members in an upstanding orientation, and a flexible, preferably transparent, sheet-like member connectable to the elongated members and extendable therebetween to provide an upstanding solid barrier to interpersonal respirational transfer of germs, viruses and the like when the sheet-like member is connected to the longitudinal members and the longitudinal members are spaced apart and supported by the bases. The flexible sheet-like member assumes a planar disposition when connected to the elongated members and the elongated members are spaced apart a distance equal to the horizontal width of the sheet-like member.

The flexible sheet-like member is desirably substantially transparent. The flexible sheet-like member is most desirably a thermal polymer that is very thin, flexible and quite transparent.

The safety shield bases have recesses for receiving the longitudinally elongated members and desirably have planar exterior surfaces facing oppositely from the recesses for supporting the bases on horizontal surfaces. The longitudinally elongated members of the shield each preferably have at least one opening formed therein and extending at least a portion of the length of the longitudinally elongated member, where each opening serves to receive an edge of the flexible member and thereby permit the flexible member to be connected to respective longitudinally elongated members, desirably along the entire longitudinal length thereof.

In another one of its aspects, this invention provides a deployable personal safety shield where the shield has a pair of longitudinally elongated members with the longitudinally elongated members each having at least one opening formed therein, with the opening extending at least a portion of the length of the longitudinally elongated member. The openings in the longitudinally elongated members preferably each have a closed bottom, with a V-shaped notch formed in the bottom for receivably retaining an edge of a preferably transparent flexible sheet-like member therein. The longitudinally elongated members are preferably sufficiently rigid to remain straight when inserted into the recesses in bases and engaged thereby.

In this aspect of the invention the deployable safety shield further includes a pair of bases for supporting the respective longitudinally elongated members in an upstanding orientation with the bases having recesses for receiving the respective longitudinally elongated members and retaining the longitudinally elongated members therein, with the bases further having planar exterior surfaces facing oppositely from the recesses for supporting the bases on horizontal surfaces. The deployable personal safety shield in this aspect of the invention further includes a transparent thermopolymer flexible sheet-like member that is connectable to the upstanding longitudinally elongated members and is extendable therebetween to provide an upstanding planar transparent shield when the longitudinally members are spaced apart and supported in their upstanding disposition by the bases. The flexible character of the sheet-like member permits the sheet-like member to assume a planar disposition when connected to the elongated members and the longitudinally elongated members are spaced apart a distance equal to horizontal width of the sheet-like member. The flexible character of the sheet-like member allows it to be rolled up for shipping of the deployable personal safety shield, thereby reducing shipping costs and facilitating storage of the deployable personal safety shield.

The longitudinally elongated members are preferably tubular with the opening in each of the longitudinally elongated members being generally V-shaped with the opening having a mouth formed in the wall portion of the tube. The opening has a closed bottom with a notch formed therein defining the vertex of the “V”; the notch receivably retains an edge of the flexible sheet-like member therein when the shield is assembled. Parts of the wall portion forming the opening converge from the mouth with increasing distance from the tube's exterior, proceeding towards the tube interior. The V-shape of the opening is truncated within the tube with converging parts of the opening remote from the mouth and the tube exterior join to define a continuous bottom of the opening. Specifically, the opening is in the wall of the longitudinal member and is formed with the longitudinal member exterior surface curving in a smooth, continuous manner to forming the mouth, the V-shaped portion of the opening, and the closed bottom of the opening; the notch is formed in the closed bottom of the opening. The notch is preferably of a width retaining the flexible member in place upon an edge of the flexible member being urged into the opening, through the mouth and into the notch.

The bases of the deployable personal safety shield may desirably be magnetic. The bases may further comprise magnets fixedly secured to the bases and positioned to face oppositely from the recesses in the bases, which receive the longitudinal members, resulting the bases adhering to magnetic surfaces. Alternatively, the bases may further include suction cups positioned to face oppositely from the recesses, for adhering the bases to smooth surfaces.

The bases have receptacles for receiving the longitudinal members therein; the receptacles are desirably of a depth sufficient to retain the longitudinally elongated members therein when the longitudinal members are inserted thereinto. The receptacles have an interior configuration that closely matches the exterior shape of the longitudinal members. Preferably the longitudinal members are of generally cylindrical configuration and the recesses in the bases are of matching size and configuration.

The following description is merely exemplary in nature and is not intended to limit the described embodiments of the invention or uses of the described embodiments. As used herein, the words “exemplary” and “illustrative” mean “serving as an example, instance, or for illustration.” Any implementation or embodiment or abstract disclosed herein as being “exemplary” or “illustrative” is not necessarily to be construed as preferred or advantageous over other implementations, aspects, or embodiments. All of the implementations or embodiments described in the following description are exemplary implementations and embodiments provided to enable persons of skill in the art to make and to use the implementations and embodiments as disclosed below, to otherwise practice the invention, and are not intended to limit the scope of the invention.

### DESCRIPTION OF THE DRAWINGS

FIG. 1 is front elevation view of the deployable personal safety shield in accordance of the invention, with the shield deployed.

FIG. 2 is a right side elevation view of the deployable personal safety shield illustrated in FIG. 1, in accordance with the invention.

FIG. 3 is a top view of the deployable personal safety shield illustrated in FIGS. 1 and 2, in accordance with the invention.

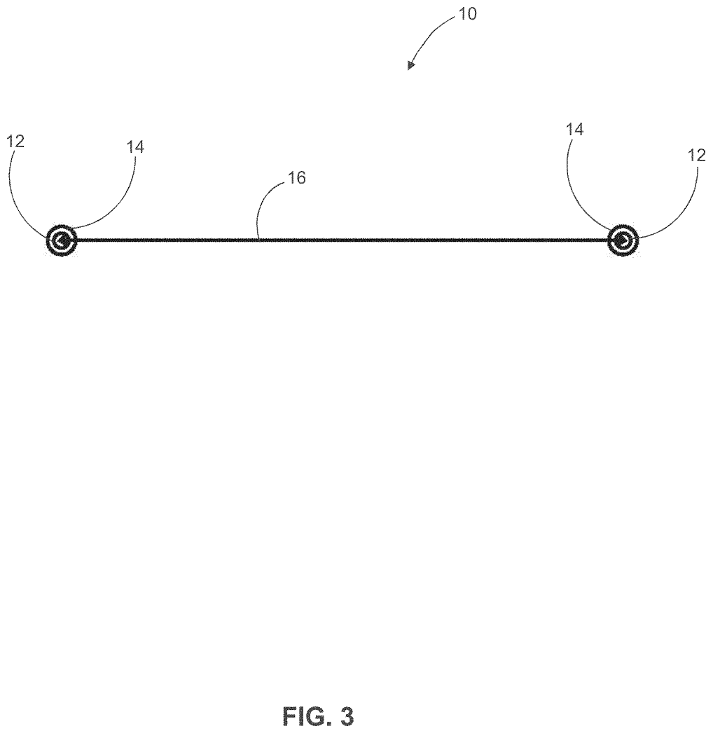

FIG. 4 is a bottom view of the deployable personal safety shield illustrated in FIGS. 1, 2 and 3, in accordance of the invention.

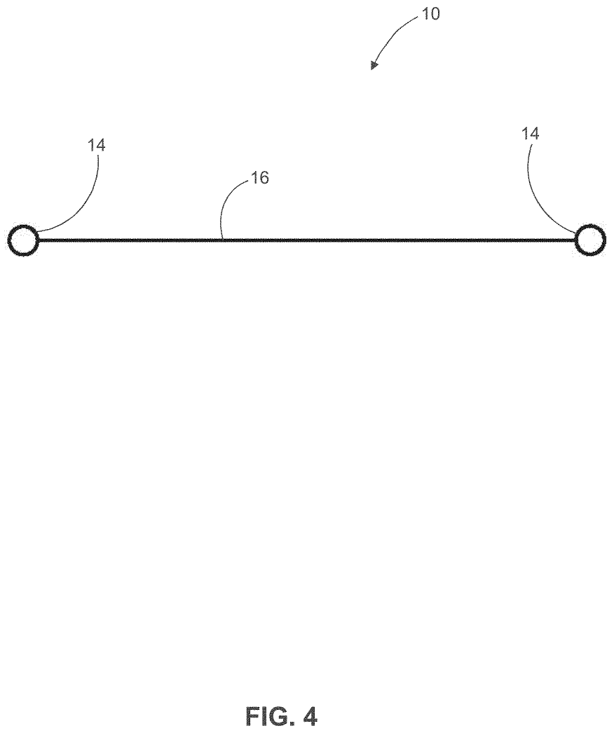

FIG. 5 is a front elevation view similar to FIG. 1 but with the flexible member of the deployable personal safety shield relaxed, in accordance of the invention.

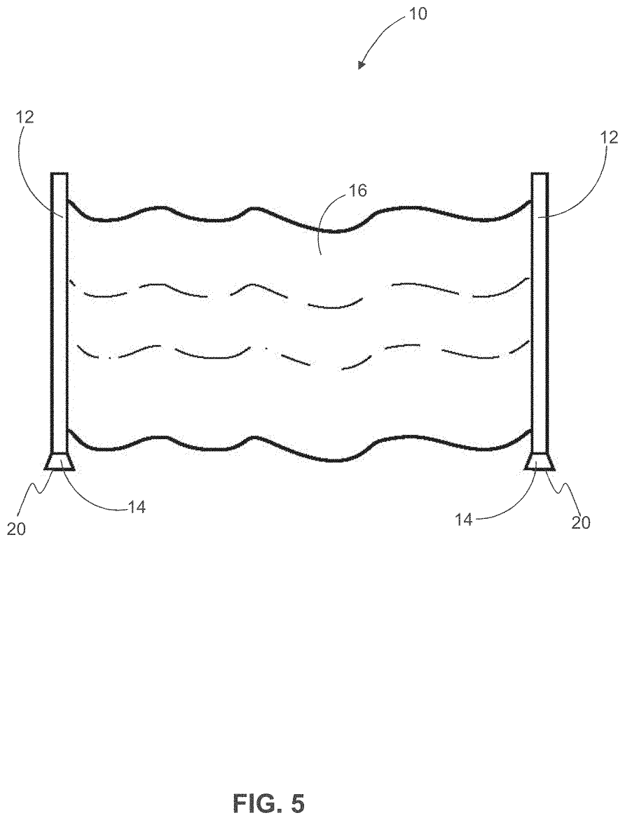

FIG. 6 is a transverse sectional view of one of the longitudinally elongated members of the deployable personal safety shield, showing the opening and notch structure that serves to retain a sheet-like member in place when the deployable personal safety shield is deployed.

FIG. 7 is an artist's depiction of the deployable safety shield in accordance with the invention deployed and being used in a workplace to safely separate and space apart two employees whose work stations face one another.

FIG. 8 is an artist's depiction of the deployable safety shield in accordance with the invention deployed and being used in a workplace to safely separate an employee whose work station is between two other employee work stations, which are not shown.

FIG. 9 is an artist's depiction of the deployable safety shield in accordance with the invention deployed and being used in a workplace to safely separate and space apart two employees whose work stations face are adjacent one to another.

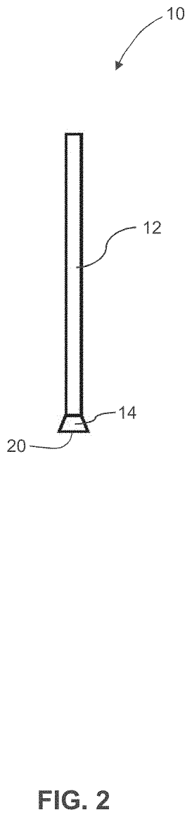

The left side view of the deployable personal safety shield in accordance with the invention is a mirror image of FIG. 2.

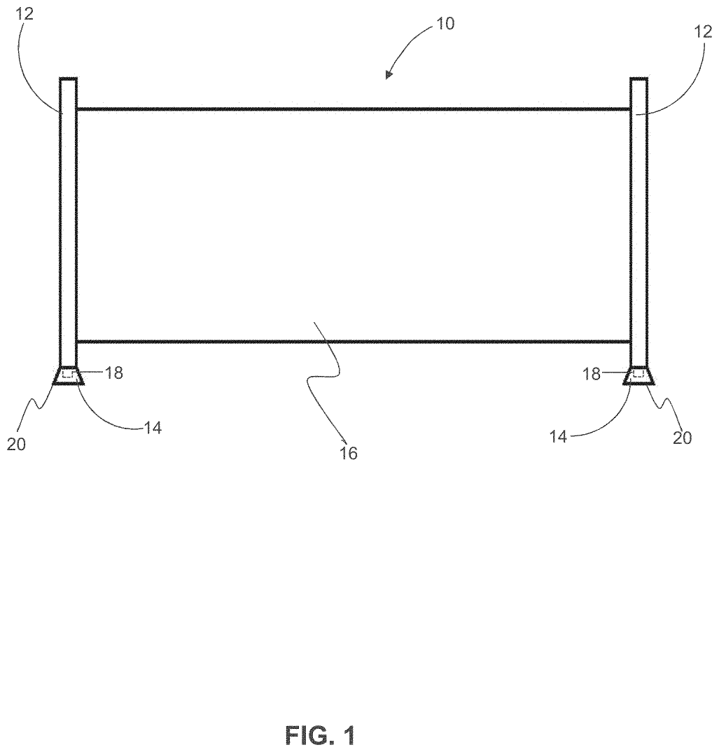

The rear view of the deployable personal .safety shield in accordance with the invention, when the shield is deployed, is a mirror image of FIG. 1.

### DESCRIPTION OF THE INVENTION

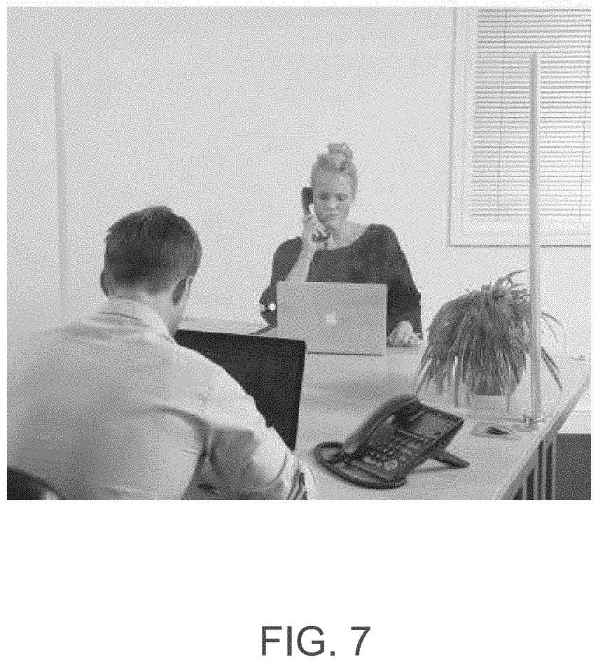

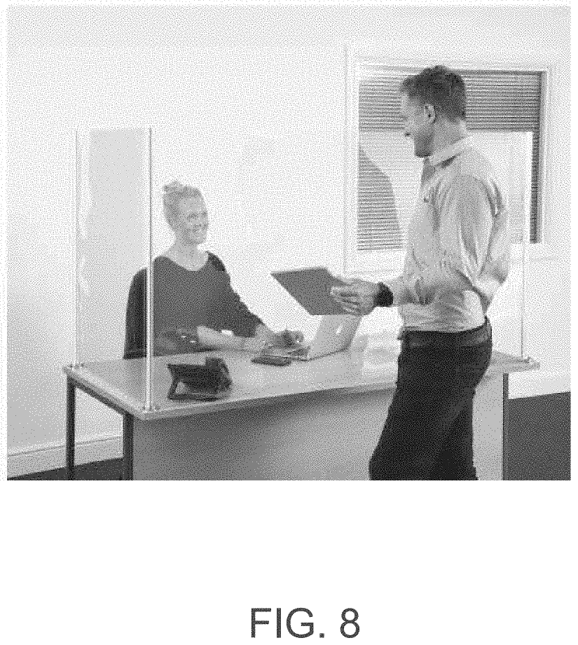

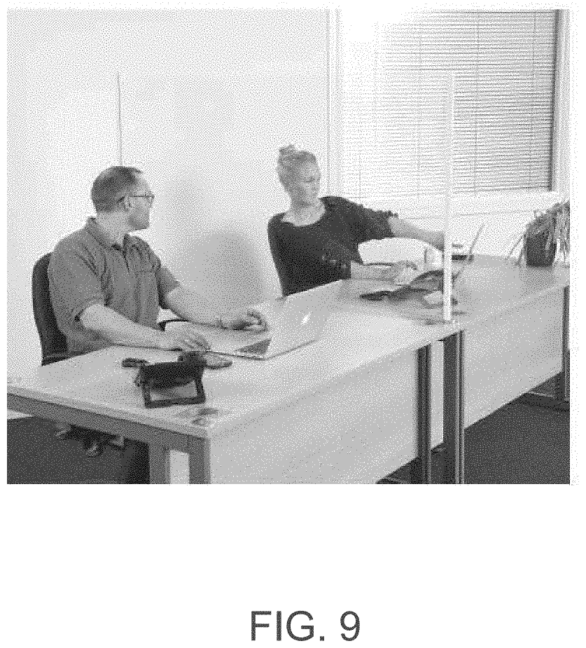

Referring to the drawings in general and in particular to FIG. 1, a deployable personal safety shield embodying aspects of the invention is designated as generally 10 and includes a pair of longitudinally elongated members, each of which is designated 12, and a pair of bases each of which is designated 14. Bases 14 have recesses 18 formed therein to receive end portions of the longitudinally elongated members 12 so the bases 14 retain longitudinally elongated members 12 in an upright vertical orientation with respect to a horizontal surface on which bases 14 preferably reside, as best illustrated in FIGS. 7, 8 and 9.

The deployable personal safety shield 10 further includes a sheet-like member 16 which is preferably transparent and is further preferably a thermopolymer such as polyvinyl chloride or polyvinylidene fluoride. Sheet like member 16 is sufficiently thin as to allow folding, roll-up and similar manipulation of sheet-like member 16 to facilitate positioning the deployable personal safety shield 10 in a compact position for storage or transport.

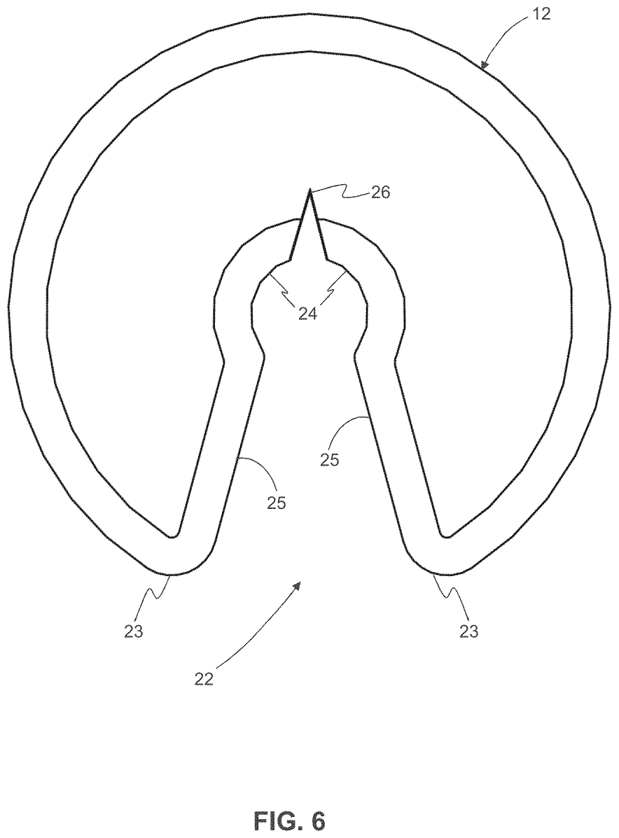

Each of the longitudinally extending members 12 includes an opening formed therein where the opening is designated 22 in FIG. 6. Opening 22 preferably runs the entire length of longitudinally elongated member 12. Opening 22 has a mouth 23 which along a smooth, continuous surface to a continuous closed bottom denoted 24 formed by converging parts of opening 22, which converging parts are designated 25 and come together at a V-shaped notch 26 formed in closed bottom portion 24 of the opening in the exterior of the tube as opening 22. The surfaces defining opening 22, including mouth 23, converging parts 25, and closed bottom portion 24 are all extensions of the unnumbered exterior surface of longitudinally extending member 12; the surfaces defining opening 22, mouth 23, converging parts 25 and closed bottom 24 are all smooth, lead continuously from one to another and are all formed from the wall of longitudinally extending member 12 as that member is fabricated, most desirably by extrusion.

With opening 22 running the longitudinal length of the elongated members 12, sheet-like member 16 can be retained within longitudinally elongated members 12 at the horizontal extremities of sheet-like member 16 so that sheet-like member provides a vertically extending, horizontally elongated transparent shield which may be positioned between adjacent workers in a workplace, between adjacent students in a school and the like, all as illustrated in FIGS. 7,8 and 9.

Mouth 23 of opening 22 is sufficiently large to allow the edge of sheet-liker member 16 to be inserted therein and urged into notch 26. As sheet-like member 16 is desirably stretched, which may be done manually, sheet-like member 16 slides into mouth 23 and is can be urged into 26 where upon sheet-like member will be retained within longitudinally elongated member 12 with the vertical length of an edge of sheet-like member 26 being retained in longitudinally elongated member 12.

Longitudinally elongated member 12 is preferably aluminum, most preferably extruded, and is tubular in form such that the opening 22 in longitudinally elongated member 12 is formed in a wall portion of the tube such that the wall portion forms mouth 23 of opening 22, with the wall of longitudinally elongated member additionally forming parts 25 of opening 22 converging with distance from the tube exterior, with converging parts 25 remote from the tube exterior joining to define a continuous bottom 24 of the opening 22. A preferably V-shaped notch 26 is formed in bottom 24 at a position equally distant from the unnumbered edges of mouth 23 of opening 22.

Bases 14 are preferably magnetic and may include magnets fixedly secured to the bases and positioned oppositely from the recesses in the bases 14 that receive longitudinally elongated members 12, in order for the bases to adhere to magnetic surfaces. Bases 14 may be fabricated of a magnetic iron alloy. Alternatively, magnets may be secured to bases 14 by screws, by adhesive, or other suitable means known well to those of skill in the art. Further alternatively, the bases may be equipped with suction cups to adhere to horizontal surfaces so as to position the sheet-like member in a vertical orientation to be most efficient in separating and providing a barrier in between adjacent workers in a workplace or adjacent students in a school.

If difficulty is encountered when deploying the personal safety shield of the 10 of the invention, sheet-like members 16 may be wrapped around members 12 a few times to whereupon the friction between sheet-like 16 and the elongated members 12 will secure the sheet-like member 16 in position so that sheet-like member 12 remains in an upright, planar disposition to provide the desired preferably transparent safety shield between adjacent workers or students as needed. Accordingly, the precise dimensions of V-shaped notch 26 and converging parts of mouth 25 are not critical and should be varied according to the particular thickness of sheet-like member 16, the material chosen for sheet-like member 16, the electrostatic properties of sheet-like member 16, namely mainly whether sheet-like 16 has any “clean” property associated with it and the like. Those of skill in the mechanical arts who are conversant with plastics molding, extrusion and are conversant with associated “mechanical” articles for fabricating parts such as bases 14 and longitudinally elongated members 12 will quickly select a desired, functional and workable set of dimensions for opening 22, notch 26, and the like, as well as for the recesses in bases 14.

As disclosed above and from the foregoing description of exemplary embodiments of the invention, it will be readily apparent to those skilled in the art to which the invention pertains that the principles and particularly the compositions and methods disclosed herein can be used for applications other than those specifically mentioned. Further, as one of skill in the art will readily appreciate from the disclosure of the invention as set forth hereinabove, apparatus, methods, and steps presently existing or later developed, which perform substantially the same function or achieve substantially the same result as the corresponding embodiments described and disclosed hereinabove, may be utilized according to the description of the invention and the claims appended hereto. Accordingly, the appended claims are intended to include within their scope such apparatus, methods, and processes that provide the same result or which are, as a matter of law, embraced by the doctrine of the equivalents respecting the claims of this application.

As respecting the claims appended hereto, the term “comprising” means “including but not limited to”, whereas the term “consisting of” means “having only and no more”, and the term “consisting essentially of” means “having only and no more except for minor additions which would be known to one of skill in the art as possibly needed for operation of the invention.” The scope of the invention is, therefore, indicated by the appended claims rather than by the foregoing description and all changes which come within the range of equivalency of the claims are to be considered to be embraced within the scope of the claims. Additional objects, other advantages, and further novel features of the invention will become apparent from study of the appended claims as well as from study of the foregoing detailed discussion and description of the preferred embodiments of the invention, as that study proceeds.

The following is claimed:

1) A deployable personal safety shield comprising:
a) a pair of longitudinally elongated members;
b) a pair of bases for supporting the longitudinally elongated members in an upstanding orientation; and
c) a flexible sheet-like member connectable the longitudinally elongated members and extendable therebetween to provide an upstanding shield when the longitudinal members are spaced apart and supported by the bases.

2) The deployable personal safety shield of claim 1 wherein the sheet-like flexible member is planar when connected the elongated members and the elongated members are spaced apart the horizontal width of the shield.

3) The deployable personal safety shield of claim 1 wherein the flexible sheet-like member is transparent.

4) The deployable personal safety shield of claim 3 wherein the sheet-like flexible member is a thermopolymer.

5) The deployable personal safety shield of claim 1 wherein the bases have recesses for receiving the longitudinally elongated members and retaining the longitudinally elongated members therein, and further have planar exterior surfaces facing oppositely from the recesses for supporting the bases on a horizontal surface.

6) The deployable personal safety shield of claim 1 wherein the longitudinally elongated members have at least one opening formed therein extending at least a portion of the longitudinal length of the longitudinally elongated member, the opening having a closed bottom with a notch formed in the bottom for receivably retaining an edge of the flexible sheet-like member therein.

7) The deployable personal safety shield of claim 1 wherein the longitudinally elongated members are sufficiently rigid to remain straight when inserted into the recesses and engaged by the bases.

8) The deployable personal safety shield of claim 1 wherein the longitudinally elongated members are metal.

9) The deployable personal safety shield of claim 8 wherein the metal is aluminum.

10) The deployable personal safety shield of claim 9 wherein the longitudinally elongated members are tubular, the opening in each having a mouth formed in a wall portion of the tube, parts of the wall portion forming the opening converging along a V-shape with distance from the tube exterior, the V-shape being truncated within the tube, converging parts of the mouth remote from the tube exterior joining to define a continuous bottom of the opening.

11) The deployable personal safety shield of claim 10 further comprising the opening having a notch defining the vertex of the “V” in the continuous bottom of the opening, the notch being of shape to retain the flexible member in place upon an edge of the flexible member being urged into the opening, through the mouth, and into the notch defining the vertex of the “V”.

12) The deployable personal safety shield of claim 1 wherein the bases are magnetic.

13) The deployable personal safety shield of claim 1 wherein the bases further comprise suction cups positioned facing oppositely from the recesses, for adhering the bases to smooth surfaces.

14) The deployable personal safety shield of claim 1 wherein the bases further comprise magnets fixedly secured to the bases and positioned facing oppositely from the recesses for adhering to magnetic surfaces.

15) A deployable personal safety shield consisting of:
a) a pair of longitudinally elongated extruded aluminum tubular members each having at least one opening formed therein extending at least a portion of the longitudinal length thereof, the elongated members being sufficiently rigid to remain straight when inserted into the recesses in bases and engaged thereby;
b) a pair of bases for supporting the elongated members in an upstanding orientation, the bases have cylindrical recesses for receiving the longitudinally elongated tubular members and retaining the longitudinally elongated members therein, and further have planar exterior surfaces facing oppositely from the recesses for supporting the bases on a horizontal surface;
c) a transparent thermopolymer flexible sheet-like member connecting the elongated members and extendable therebetween to provide an upstanding shield when the longitudinal members are spaced apart and supported by the bases, the flexible sheet-like member being planar when connected the elongated members and the elongated members are spaced apart a distance the horizontal width of the sheet-like flexible member;
d) the opening in each of the longitudinally elongated members being generally V-shaped and formed in a wall portion of the tube, the opening having a closed bottom with a notch formed therein defining the vertex of the “V” for receivably retaining an edge of the flexible sheet-like member therein, parts of the wall portion forming the opening converging from the mouth with distance from the tube exterior, the V-shape being truncated within the tube, converging parts of the opening remote from the tube exterior joining to form the surface of the opening as being a smooth continuous surface;
e) the notch of the “V” being of shape and width for retaining the flexible member in place upon an edge of the flexible member being urged through the opening and into the notch.

16) A deployable personal safety shield comprising:
a) a pair of longitudinally elongated tubular aluminum members each having an opening formed in the wall of the tube and extending the longitudinal length of the member, the openings each having a mouth and a closed bottom with a V-shaped notch formed in the bottom for receivably retaining an edge of a flexible transparent planar thermopolymer sheet-like member therein; parts of the wall portion forming the opening converging away from the tube exterior and forming a truncated V-shape within the tube; converging parts of the opening remote from the tube exterior joining to define a continuous opening bottom; the bottom having a notch defining the vertex of the “V” in the continuous bottom of the opening, the “V” being of size and shape to admit and retain a flexible member upon an edge of the flexible member being urged into the opening and then into the notch defining the vertex of the “V”; the longitudinally elongated members being sufficiently rigid to remain straight when inserted into the recesses in bases and engaged thereby;
b) the bases being a pair and having tubular recesses for receiving the longitudinally elongated members and retaining the longitudinally elongated members therein in a vertically upstanding orientation, having planar exterior surfaces facing oppositely from the recesses for supporting the bases on a horizontal surface with the longitudinal members extending vertically; and
c) the flexible transparent planar thermopolymer sheet-like member being connected between the longitudinally elongated members, retained in place in the notches defining the vertices of the “V's” and extending therebetween to provide a vertically upstanding flat transparent shield when the longitudinal members are spaced apart and supported by the bases.
